(19) United States
(12) Patent Application Publication
(10) Pub. No.: US 2013/0012095 A1
(43) Pub. Date: Jan. 10, 2013

(54) PROCESS FOR PRODUCING PLASMA DISPLAY PANEL

(76) Inventors: Takuji Tsujita, Osaka (JP); Masashi Gotou, Osaka (JP); Masanori Miura, Osaka (JP); Hideji Kawarazaki, Osaka (JP); Keiji Horikawa, Osaka (JP); Chiharu Koshio, Kyoto (JP); Kanako Okumura, Osaka (JP)

(21) Appl. No.: 13/634,204

(22) PCT Filed: Mar. 17, 2011
(86) PCT No.: PCT/JP11/01574

§ 371 Date: Sep. 11, 2012

(30) Foreign Application Priority Data
Mar. 26, 2010 (JP) 2010-071990

(51) Int. Cl. H01J 9/385

(52) U.S. Cl. 445/25

(57) ABSTRACT

By introducing a gas containing a reducing organic gas into the discharge space, the protective layer is exposed to the reducing organic gas. Then, the reducing organic gas is exhausted from the discharge space. Then, a discharge gas is enclosed to the discharge space. The protective layer includes a nano particle layer formed by nano crystal particles of metal oxides containing at least a first metal oxide and a second metal oxide. Moreover, the nano particle layer has at least one peak in an X-ray diffraction analysis. The peak is located between a first peak in the X-ray diffraction analysis of the first metal oxide and a second peak in the X-ray diffraction analysis of the second metal oxide. The first peak and the second peal have the same plane orientation as the plane orientation indicated by the peak.

### TECHNICAL FIELD

A technique disclosed hereinbelow relates to a method for producing a plasma display panel to be used in a display device or the like.

### BACKGROUND ART

A plasma display panel (hereinafter, referred to as a PDP) has a front plate and a rear plate. The front plate has a glass substrate, a display electrode formed on one main surface of the glass substrate, a dielectric layer to cover the display electrode and function as a capacitor, and a protective layer made of magnesium oxide (MgO) formed on the dielectric layer.

In order to increase the number of primary electrons released from the protective layer, for example, an attempt has been made in which silicon (Si) or aluminum (Al) is added to MgO in the protective layer (for example, see Patent Literatures 1, 2, 3, 4, 5, etc.).

### CITATION LIST

### Patent Literature

PTL 1: Unexamined Japanese Patent Publication No. 2002-260535
PTL 2: Unexamined Japanese Patent Publication No. 11-339665
PTL 3: Unexamined Japanese Patent Publication No. 2006-59779
PTL 4: Unexamined Japanese Patent Publication No. 8-236028
PTL 5: Unexamined Japanese Patent Publication No. 10-334809

### SUMMARY OF THE INVENTION

It is a method for producing a plasma display panel having a discharge space and a protective layer that faces the discharge space. By introducing a gas containing a reducing organic gas into the discharge space, the protective layer is exposed to the reducing organic gas. Then, the reducing organic gas is exhausted from the discharge space. Then, a discharge gas is enclosed to the discharge space. The protective layer includes a nano particle layer formed by nano crystal particles of metal oxides containing at least a first metal oxide and a second metal oxide. Moreover, the nano particle layer has at least one peak in an X-ray diffraction analysis. The peak is located between a first peak in the X-ray diffraction analysis of the first metal oxide and a second peak in the X-ray diffraction analysis of the second metal oxide. The first peak and the second peak have the same plane orientation as the plane orientation indicated by the peak. The first metal oxide and the second metal oxide are two kinds of oxides selected from the group consisting of magnesium oxide, calcium oxide, strontium oxide and barium oxide.

### BRIEF DESCRIPTION OF DRAWINGS

FIG. 1 is a perspective view illustrating a structure of a PDP in accordance with an embodiment.

FIG. 2A is a cross-sectional view illustrating a configuration of a front plate according to an exemplary embodiment.

FIG. 2B is a cross-sectional view illustrating a configuration of a front plate according to an exemplary embodiment.

FIG. 3 is a view showing a production flow of the PDP according to the exemplary embodiment.

FIG. 4 is a view showing an example of a first temperature profile.

FIG. 5 is a view showing an example of a second temperature profile.

FIG. 6 is a view showing an example of a third temperature profile.

FIG. 7 is a view showing results of an X-ray diffraction analysis carried out on the surface of a base film according to the exemplary embodiment.

FIG. 8 is a view showing results of an X-ray diffraction analysis carried out on the surface of another base film according to the exemplary embodiment.

FIG. 9 is an enlarged view of aggregated particles according to the exemplary embodiment.

FIG. 10 is a graph showing a relation between a discharge delay of the PDP and a calcium concentration in the base film.

FIG. 11 is a graph showing an electron emission performance in the PDP and a Vscn lighting voltage.

FIG. 12 is a graph showing a relation between an average particle diameter of the aggregated particles and electron emission performance.

### DESCRIPTION OF EMBODIMENTS

### 1. Structure of PDP 1

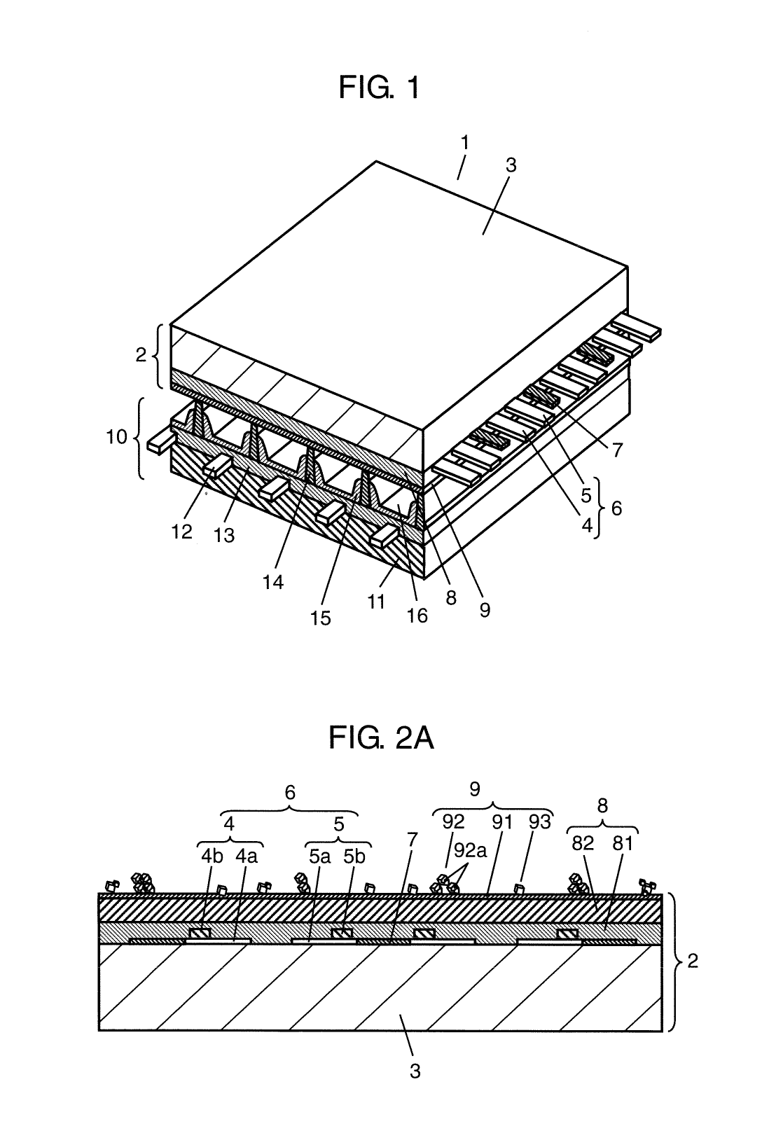

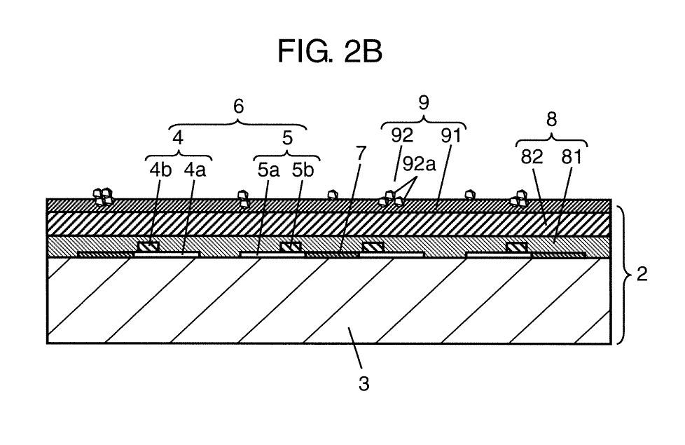

A basic structure of a PDP is a general alternating current surface discharge type PDP. As shown in FIGS. 1, 2A and 2B, PDP 1 is provided in such a manner that front plate 2 including front glass substrate 3 and the like and rear plate 10 including rear glass substrate 11 and the like are arranged so as to be opposed to each other. Front plate 2 and rear plate 10 are sealed in an air-tight manner by a sealing material made of glass frit or the like on their peripheral portions. A discharge gas such as neon (Ne) and xenon (Xe) is enclosed at a pressure of 53 kPa (400 Torr) to 80 kPa (600 Torr) into discharge space 16 provided in sealed PDP 1.

On front glass substrate 3, a plurality of rows of paired belt-shaped display electrodes 6, each composed of scan electrode 4 and sustain electrode 5, and black stripes 7 are arranged in parallel with each other. Dielectric layer 8 serving as a capacitor is formed on front glass substrate 3 so as to cover display electrodes 6 and black stripes 7. Moreover, protective layer 9 composed of magnesium oxide (MgO) or the like is formed on a surface of dielectric layer 8. Protective layer 9 will be described later in detail.

Each of scan electrode 4 and sustain electrode 5 has a structure in which a bus electrode composed of Ag is stacked on a transparent electrode composed of a conductive metal oxide such as an indium tin oxide (ITO), a tin oxide (SnO₂), or a zinc oxide (ZnO).

On rear glass substrate 11, a plurality of data electrodes 12 each composed of a conductive material mainly containing silver (Ag) are arranged in parallel with each other in a direction orthogonal to display electrodes 6. Data electrode 12 is covered with insulating layer 13. Moreover, on insulating layer 13 between data electrodes 12, barrier rib 14 having a predetermined height is formed to section discharge space 16. In a groove between barrier ribs 14, phosphor layer 15 emitting red light by ultraviolet rays, phosphor layer 15 emitting green light thereby and phosphor layer 15 emitting blue light thereby are sequentially applied and formed for each of data electrodes 12. A discharge cells is formed at a position in which display electrode 6 and data electrode 12 intersect with each other. The discharge cell having phosphor layers 15 of red, green and blue colors aligned in a direction along discharge electrode 6 serves as a pixel for a color display.

Additionally, in the present exemplary embodiment, the discharge gas sealed in discharge space 16 contains 10% by volume or more and 30% by volume or less of Xe.

### 2. Method for Producing PDP 1

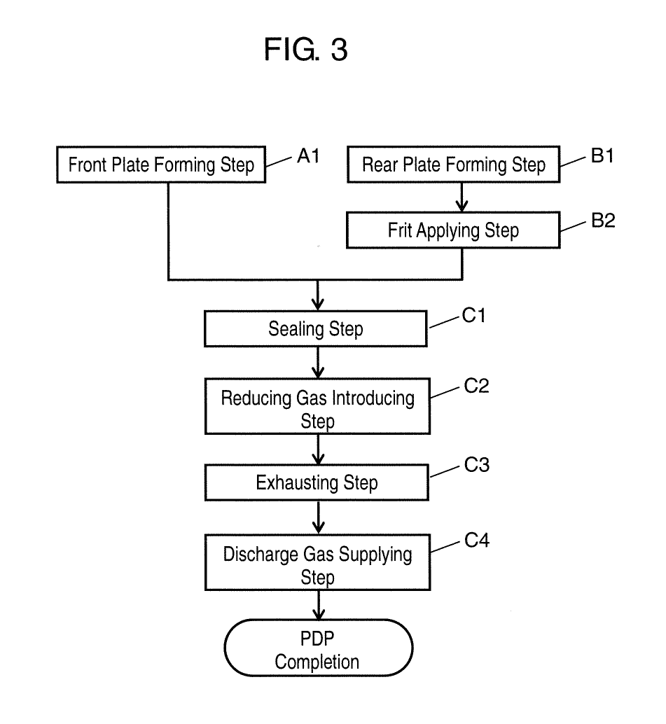

As shown in FIG. 3, the method for producing PDP 1 according to the present exemplary embodiment includes front plate forming step A1, rear plate forming step B1, frit applying step B2, sealing step C1, reducing gas introducing step C2, exhausting step C3 and discharge gas supplying step C4.

### 2-1. Front Plate Forming Step A1

In front plate forming step A1, scan electrode 4, sustain electrode 5 and black stripe 7 are formed on front glass substrate 3 by a photolithography method. Scan electrode 4 and sustain electrode 5 have metal bus electrode 4b and metal bus electrode 5b containing silver (Ag) for ensuring conductivity, respectively. Moreover, scan electrode 4 and sustain electrode 5 have transparent electrode 4a and transparent electrode 5a, respectively. Metal bus electrode 4b is stacked on transparent electrode 4a. Metal bus electrode 5b is stacked on transparent electrode 5a.

As a material for transparent electrodes 4a and 5a, indium tin oxide (ITO) or the like is used so as to ensure transparency and electric conductivity. First, an ITO thin film is formed on front glass substrate 3 by a sputtering method. Then, transparent electrodes 4a and 5a are formed into predetermined patterns by a photolithography method.

As a material for metal bus electrodes 4b and 5b, an electrode paste containing silver (Ag), a glass frit to bind the silver, a photosensitive resin, a solvent, and the like is used. First, the electrode paste is applied onto front glass substrate 3 by a screen printing method or the like. Then, the solvent is removed from the electrode paste in a baking oven. Then, the electrode paste is exposed to light through a photo-mask having a predetermined pattern.

Then, the electrode paste is developed so that a metal bus electrode pattern is formed. Finally, the metal bus electrode pattern is fired at a predetermined temperature in a baking oven. In other words, the photosensitive resin is removed from the metal bus electrode pattern. Moreover, the glass frit in the metal bus electrode pattern is melt. The melt glass frit is again vitrified after the firing step. Through the above-mentioned steps, metal bus electrodes 4b and 5b are formed.

Black stripe 7 is made of a material containing a black pigment. Then, dielectric layer 8 is formed. Then, dielectric layer 8 and protective layer 9 are formed. Dielectric layer 8 and protective layer 9 will be described later in detail.

Through the above-mentioned steps, front plate 2 having predetermined constituent members is completed on rear glass substrate 3.

### 2-2. Rear Plate Forming Step B1

Data electrode 12 is formed on rear glass substrate 11 by a photolithography method. As a material for data electrode 12, a data electrode paste containing silver (Ag) for ensuring conductivity, a glass frit to bind the silver, a photosensitive resin, a solvent, and the like is used. First, the data electrode paste is applied onto rear glass substrate 11 with a predetermined thickness by a screen printing method or the like. Then, the solvent is removed from the data electrode paste in a baking oven. Then, the data electrode paste is exposed to light through a photo-mask having a predetermined pattern. Then, the data electrode paste is developed so that a data electrode pattern is formed. Finally, the data electrode pattern is fired at a predetermined temperature in a baking oven. In other words, the photosensitive resin is removed from the data electrode pattern. Moreover, the glass frit in the data electrode pattern is melt. The melt glass frit is again vitrified after the firing step. Through the above-mentioned steps, data electrode 12 is formed. Here, the data electrode paste may be applied by a sputtering method, a vapor deposition method or the like other than the screen printing method.

Then, insulating layer 13 is formed. As a material for insulating layer 13, an insulating paste containing a dielectric glass frit, a resin, a solvent, and the like is used. First, the insulating paste is applied onto rear glass substrate 11, on which data electrode 12 has been formed, with a predetermined thickness in a manner so as to cover data electrodes 12 by a screen printing method or the like. Then, the solvent is removed from the insulating paste in a baking oven. Finally, the insulating paste is fired at a predetermined temperature in a baking oven. In other words, the resin is removed from the insulating layer. Moreover, the dielectric glass frit is melt. The melt dielectric glass frit is again vitrified after the firing step. Through the above-mentioned steps, insulating layer 13 is formed. Here, the insulating paste may be applied by a die coating method, a spin coating method, or the like other than the screen printing method. Moreover, without using the insulating paste, a film used as insulating layer 13 can be formed by a CVD (Chemical Vapor Deposition) method, or the like.

Then, barrier rib 14 is formed by a photolithography method. As a material for barrier rib 14, a barrier rib paste containing filler, a glass frit to bind the filler, a photosensitive resin, a solvent, and the like is used. First, the barrier rib paste is applied onto insulating layer 13 with a predetermined thickness by a die coating method or the like. Then, the solvent is removed from the barrier rib paste in a baking oven. Then, the barrier rib paste is exposed to light through a photo-mask having a predetermined pattern. Then, the barrier rib paste is developed so that a barrier rib pattern is formed. Finally, the barrier rib pattern is fired at a predetermined temperature in a baking oven. In other words, the photosensitive resin is removed from the barrier rib pattern. Moreover, the glass frit in the barrier rib pattern is melt. The melt glass frit is again vitrified after the firing step. Through the above-mentioned steps, barrier rib 14 is formed. Here, a sand blasting method or the like may be used other than the photolithography method.

Then, phosphor layer 15 is formed. As a material for phosphor layer 15, a phosphor paste containing phosphor particles, a binder, a solvent, and the like is used. First, the phosphor paste is applied onto insulating layer 13 between adjacent barrier ribs 14 as well as a side face of barrier rib 14 with a predetermined thickness by a dispensing method or the like. Then, the solvent is removed from the phosphor paste in a baking oven. Finally, the phosphor paste is fired at a predetermined temperature in a baking oven. In other words, the resin is removed from the phosphor paste. Through the above-mentioned steps, phosphor layer 15 is formed. Here, a screen printing method or the like may be used other than the dispensing method.

Through the above-mentioned steps, rear plate 10 having predetermined constituent members is completed on rear glass substrate 11.

### 2-3. Frit Applying Step B2

A glass frit serving as a sealing member is applied onto the outside of an image display area of rear plate 10 formed in rear plate production step B1. Then, the glass frit is calcined at a temperature of about 350° C. The solvent components and the like are removed by the calcination step.

As the sealing member, frit mainly composed of bismuth oxide or vanadium oxide is desirable. As the frit mainly composed of bismuth oxide, for example, a material, prepared by adding filler made of an oxide such as Al₂O₃, SiO₂ or cordierite to a Bi₂O₃—B₂O₃—RO-MO series (wherein, R represents any of Ba, Sr, Ca and Mg, and M represents any of Cu, Sb and Fe) glass material, may be used. Moreover, as the frit mainly composed of vanadium oxide, for example, a material, prepared by adding filler made of an oxide such as Al₂O₃, SiO₂ or cordierite to a V₂O₅—BaO—TeO—WO series glass material, may be used.

### 2-4. From Sealing Step C1 to Discharge Gas Supplying Step C4

Front plate 2 and rear plate 10 having been subjected to frit coating step B1 are arranged so as to be opposed to each other so that the peripheral portions thereof are sealed with a sealing member. Thereafter, a discharge gas is enclosed to discharge space 16.

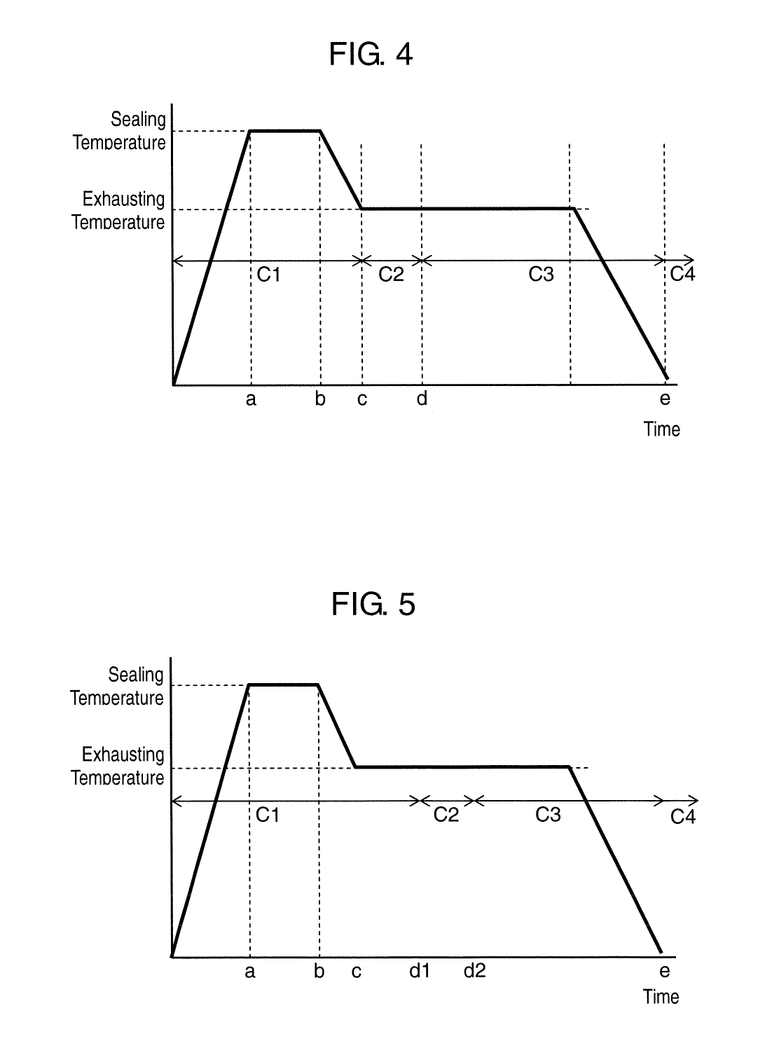

In sealing step C1, reducing gas introducing step C2, exhausting step C3 and discharge gas supplying step C4 according to the present exemplary embodiment, treatments having temperature profiles exemplified in FIGS. 4 to 6 are carried out in the same device.

A sealing temperature indicated in FIGS. 4 to 6 refers to a temperature at which front plate 2 and rear plate 10 are sealed with each other by a frit serving as a sealing material. In the present exemplary embodiment, the sealing temperature is, for example, about 490° C. Moreover, a softening point indicated in FIGS. 4 to 6 refers to a temperature at which a frit serving as a sealing material starts to soften. The softening point in the present exemplary embodiment is, for example, about 430° C. Furthermore, an exhaust temperature indicated in FIGS. 4 to 6 refers to a temperature at which a gas containing a reducing organic gas is exhausted from the discharge space. In the present exemplary embodiment, the exhaust temperature is, for example, about 400° C.

### 2-4-1. First Temperature Profile

As shown in FIG. 4, first, in sealing step C1, the temperature is raised from room temperature to a sealing temperature. Then, during a period of a-b, the temperature is maintained at the sealing temperature. Thereafter, the temperature is lowered from the sealing temperature to an exhaust temperature during a period of b-c. In the period of b-c, the discharge space is exhausted. That is, the discharge space is brought to a reduced pressure state.

Then, in reducing gas introducing step C2, the temperature is maintained at the exhaust temperature during a period of c-d. During the period of c-d, a gas containing a reducing organic gas is introduced into the discharge space. During the period of c-d, protective layer 9 is exposed to the gas containing a reducing organic gas.

Thereafter, in exhausting step C3, the temperature is maintained at the exhaust temperature for a predetermined period of time. Then, the temperature is lowered to room temperature. In a period of d-e, since the discharge space is exhausted, the gas containing a reducing organic gas is exhausted.

Then, in discharge gas supplying step C4, a discharge gas is introduced into the discharge space. That is, during a period from a point e and thereafter, with its temperature dropped to about room temperature, the discharge gas is introduced.

### 2-4-2. Second Temperature Profile

As shown in FIG. 5, first, in sealing step C1, the temperature is raised from room temperature to a sealing temperature. Then, during a period of a-b, the temperature is maintained at the sealing temperature. Thereafter, the temperature is lowered from the sealing temperature to an exhaust temperature during a period of b-c. During a period of c-d1 at which the temperature is maintained at the exhaust temperature, the discharge space is exhausted. That is, the discharge space is brought to a reduced pressure state.

Then, in reducing gas introducing step C2, the temperature is maintained at the exhaust temperature during a period of d1-d2. During the period of d1-d2, a gas containing a reducing organic gas is introduced into the discharge space. During the period of d1-d2, protective layer 9 is exposed to the gas containing a reducing organic gas.

Thereafter, in exhausting step C3, the temperature is maintained at the exhaust temperature for a predetermined period of time. Then, the temperature is lowered to room temperature. In a period of d2-e, since the discharge space is exhausted, the gas containing a reducing organic gas is exhausted.

Then, in discharge gas supplying step C4, a discharge gas is introduced into the discharge space. That is, during a period from a point e and thereafter, with its temperature dropped to about room temperature, the discharge gas is introduced.

### 2-4-3. Third Temperature Profile

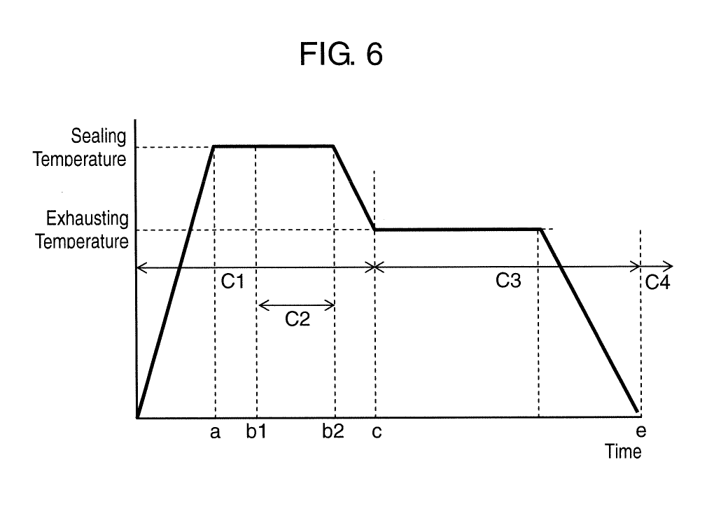

As shown in FIG. 6, first, in sealing step C1, the temperature is raised from room temperature to a sealing temperature. Then, during a period of a-b1-b2, the temperature is maintained at the sealing temperature. Then, during a period of a-b1, the discharge space is exhausted. That is, the discharge space is brought to a reduced pressure state. Thereafter, the temperature is lowered from the sealing temperature to an exhaust temperature during a period of b2-c.

Reducing gas introducing step C2 is carried out within the period of sealing step C1. The temperature is maintained at the sealing temperature during a period of b1-b2. Thereafter, within a period of b2-c, the temperature is lowered to the exhaust temperature. During the period of b1-c, a gas containing a reducing organic gas is introduced into the discharge space. During the period of b1-c, protective layer 9 is exposed to the gas containing a reducing organic gas.

Thereafter, in exhausting step C3, the temperature is maintained at the exhaust temperature for a predetermined period of time. Then, the temperature is lowered to room temperature. In a period of c-e, since the discharge space is exhausted, the gas containing a reducing organic gas is exhausted.

Then, in discharge gas supplying step C4, a discharge gas is introduced into the discharge space. That is, during a period from a point e and thereafter, with its temperature dropped to about room temperature, the discharge gas is introduced.

Additionally, in any of the temperature profiles, approximately the same function is exerted.

### 2-4-4. Detailed Description of Reducing Organic Gas

As shown in Table 1, a CH-based organic gas having a molecular weight of 58 or less, with a high reducing function, is desirably used as the reducing organic gas. By mixing at least one gas selected from various reducing organic gases with a rare gas, nitrogen gas, or the like, a gas containing an organic gas is produced.

TABLE 1

| | | | Molecular | Vapor | Boiling | Easiness in | Reducing |
|---|---|---|---|---|---|---|---|
| Organic gas | C | H | weight | pressure | point | decomposition | function |
| Acetylene | 2 | 2 | 26 | A | A | A | A |
| Ethylene | 2 | 4 | 28 | A | A | A | A |
| Ethane | 2 | 6 | 30 | A | A | B | A |
| Methylacetylene | 3 | 4 | 40 | A | A | A | A |
| Propadiene | 3 | 4 | 40 | A | A | A | A |
| Propylene | 3 | 6 | 42 | A | A | A | A |
| Cyclopropane | 3 | 6 | 42 | A | A | A | A |
| Propane | 3 | 8 | 44 | A | A | B | A |
| 1-Butyne | 4 | 6 | 54 | C | C | A | A |
| 1,2-Butadiene | 4 | 6 | 54 | A | C | A | A |
| 1,3-Butadiene | 4 | 6 | 54 | A | A | A | A |
| Ethylacetylene | 4 | 6 | 54 | C | C | A | A |
| 1-Butene | 4 | 8 | 56 | A | A | A | A |
| Butane | 4 | 10 | 58 | A | A | B | A |

In Table 1, column C represents the number of carbon atoms contained in one molecule of an organic gas. Column H represents the number of hydrogen atoms contained in one molecule of the organic gas.

As shown in Table 1, in the column of vapor pressure, each gas having a vapor pressure of 100 kPa or higher at 0° C. is denoted as “A”. Moreover, each gas having a vapor pressure lower than 100 kPa at 0° C. is denoted as “C”. In the column of boiling point, each gas having a boiling point of 0° C. or lower at 1 atmospheric pressure is denoted as “A”. Moreover, each gas having a boiling point higher than 0° C. at 1 atmospheric pressure is denoted as “C”. In the column of easiness in decomposition, each gas that is easily decomposed is denoted as “A”. Each gas that is normally decomposed is denoted as “B”. In the column of reducing function, each gas having a sufficient reducing function is denoted as “A”.

In Table 1, “A” means a good characteristic. “B” means a normal characteristic. “C” means an insufficient characteristic.

From the viewpoint of easiness in handling of an organic gas in the PDP production step, a reducing organic gas that can be charged into a gas cylinder and supplied is desirable. Moreover, from the viewpoint of easiness in handling during the PDP production step, a reducing organic gas having a vapor pressure of 100 kPa or higher at 0° C., or a reducing organic gas having a boiling point of 0° C. or lower, or a reducing organic gas having a small molecular weight is desirable.

There is a possibility that one portion of the gas containing a reducing organic gas still remains in the discharge space after exhausting step C3. Therefore, the reducing organic gas is desirably provided with an easily decomposable characteristic.

By taking into consideration the easiness in handling during the production step and the easily decomposable characteristic, the reducing organic gas is desirably a hydrocarbon-based gas without containing oxygen selected from acetylene, ethylene, methylacetylene, propadiene, propylene and cyclopropane. At least one kind of gas selected from these reducing organic gases can be mixed with a rare gas or nitrogen gas to be used.

The mixing ratio of the rare gas or nitrogen gas and the reducing organic gas is determined in its lower limit in accordance with the combustion rate of the reducing organic gas to be used. Its upper limit is about several % by volume. When the mixing ratio of the reducing organic gas is too high, organic components are polymerized, and tend to form polymers. In this case, the polymers remain in the discharge space to cause influences on the characteristics of the PDP. Therefore, it is preferable to appropriately adjust the mixing ratio depending on the components of the reducing organic gas to be used.

MgO, CaO, SrO, BaO and the like are highly reactive with impurity gases such as water, carbon dioxide, hydrocarbon, and the like. In particular, when these react with water or carbon dioxide, the discharging characteristic tends to deteriorate to cause deviations in discharging characteristic in each discharge cell.

Therefore, in sealing step C1, it is preferable to allow an inert gas to flow through a through-hole that is opened to discharge space 16 so as to bring the inside of discharge space 16 into a positive pressure state, and the sealing step is then carried out. This makes it possible to suppress a reaction between base film 91 and the impurity gases. As the inert gas, for example, nitrogen, helium, neon, argon, xenon, or the like may be used.

### 3. Detailed Description of Dielectric Layer 8

As shown in FIGS. 2A and 2B, dielectric layer 8 according to the present exemplary embodiment has at least two-layer configuration including first dielectric layer 81 that covers display electrodes 6 and black stripes 7, and second dielectric layer 82 that covers first dielectric layer 81.

### 3-1. First Dielectric Layer 81

The dielectric material of first dielectric layer 81 includes 20% by weight to 40% by weight of bismuth oxide (Bi₂O₃). Moreover, the dielectric material of first dielectric layer 81 includes 0.5% by weight to 12% by weight of at least one material selected from the group of calcium oxide (CaO), strontium oxide (SrO) and barium oxide (BaO). Furthermore, the dielectric material of first dielectric layer 81 includes 0.1% by weight to 7% by weight of at least one material selected from the group of molybdenum oxide (MoO₃), tungsten oxide (WO3), cerium oxide (CeO₂), manganese dioxide (MnO₂), copper oxide (CuO), chromium oxide (Cr₂O₃), cobalt oxide (Co₂O₃), vanadium oxide (V₂O₇) and antimony oxide (Sb₂O₃).

Moreover, as components other than the above-mentioned components, material composition without containing a lead component, such as 0% by weight to 40% by weight of zinc oxide (ZnO), 0% by weight to 35% by weight of boron oxide (B₂O₃), 0% by weight to 15% by weight of silicon dioxide (SiO₂), 0% by weight to 10% by weight of aluminum oxide (Al₂O₃), and the like, may be contained therein. In this case, the contents of the material composition are not particularly limited.

A dielectric material containing the composition components is pulverized by a wet-type jet mill or a ball mill so as to have an average particle diameter of 0.5 μM to 2.5 μM. The pulverized dielectric material forms a dielectric material powder. Then, 55% by weight to 70% by weight of the dielectric material powder and 30% by weight to 45% by weight of a binder component are sufficiently kneaded by three rolls or the like so that a paste for a first dielectric layer for die coating or for printing is completed.

A binder component is ethyl cellulose, terpineol containing 1% by weight to 20% by weight of acrylic resin, or butyl carbitol acetate. Moreover, to the paste, if necessary, dioctyl phthalate, dibutyl phthalate, triphenyl phosphate, or tributyl phosphate may be added as a plasticizer. Furthermore, glycerol monooleate, sorbitan sesquioleate, Homogenol (trade name: Kao Corporation), a phosphate of an alkyl allyl group, or the like may be added thereto as a dispersant. When the dispersing agent is added thereto, printing properties are improved.

The paste for a first dielectric layer is printed onto front glass substrate 3 so as to cover display electrodes 6 by using a die coating method or a screen printing method. The paste for a first dielectric layer thus printed is subjected to a drying step, and then fired. The firing temperature is from 575° C. to 590° C., which is a temperature slightly higher than the softening point of the dielectric material.

### 3-2. Second Dielectric Layer 82

The dielectric material of second dielectric layer 82 includes 11% by weight to 20% by weight of Bi₂O₃. Moreover, the dielectric material of second dielectric layer 82 also includes 1.6% by weight to 21% by weight of at least one material selected from the group of CaO, SrO and BaO. Furthermore, the dielectric material of second dielectric layer 82 includes 0.1% by weight to 7% by weight of at least one material selected from the group of MoO₃, WO3, cerium oxide (CeO₂), CuO, Cr₂O₃, Co₂O₃, V₂O₇, Sb₂O₃ and MnO₂.

Moreover, as components other than the above-mentioned components, material composition without containing a lead component, such as 0% by weight to 40% by weight of ZnO, 0% by weight to 35% by weight of B₂O₃, 0% by weight to 15% by weight of SiO₂, 0% by weight to 10% by weight of Al₂O₃, and the like, may be contained therein. In this case, the contents of the material components are not particularly limited.

A dielectric material containing the composition components is pulverized by a wet-type jet mill or a ball mill so as to have an average particle diameter of 0.5 μm to 2.5 μm. The pulverized dielectric material forms a dielectric material powder. Then, 55% by weight to 70% by weight of the dielectric material powder and 30% by weight to 45% by weight of a binder component are sufficiently kneaded by three rolls or the like so that a paste for a second dielectric layer for die coating or for printing is completed.

Binder components in the paste for a second dielectric layer are the same as those of the paste for a first dielectric layer.

The paste for a second dielectric layer is printed onto first dielectric layer 81 by a die coating method or a screen printing method. The paste for a second dielectric layer thus printed is subjected to a drying step, and then fired. The firing temperature is from 575° C. to 590° C., which is a temperature slightly higher than the softening point of the dielectric material.

### 3-3. Film Thickness of Dielectric Layer 8

In order to ensure a sufficient visible light transmittance, a film thickness of dielectric layer 8 is preferably 41 μm or less, with first dielectric layer 81 and second dielectric layer 82 being joined together. The content of Bi₂O₃ in first dielectric layer 81 is made greater than the content of Bi₂O₃ in second dielectric layer 82 so as to suppress a reaction with Ag contained in metal bus electrodes 4b and 5b. Consequently, the visible light transmittance of first dielectric layer 81 becomes lower than the visible light transmittance of second dielectric layer 82. Therefore, the film thickness of first dielectric layer 81 is preferably made thinner than the film thickness of second dielectric layer 82.

In the case where the content of Bi₂O₃ in second dielectric layer 82 is 11% by weight or less, coloring is difficult to occur. However, bubbles tend to be easily generated in second dielectric layer 82. In the case where the content of Bi₂O₃ exceeds 40% by weight, coloring occurs easily to cause a reduction in transmittance. Therefore, the content of Bi₂O₃ is preferably more than 11% by weight and 40% by weight or less.

Moreover, the smaller the film thickness of dielectric layer 8, the more remarkable the luminance improving effect and the discharge voltage reducing effect. Therefore, the film thickness is preferably made as small as possible as long as it is within a range without causing a reduction in insulation withstand voltage. In the present exemplary embodiment, the film thickness of dielectric layer 8 is 41 μm or less. Moreover, the film thickness of first dielectric layer 81 is 5 μm to 15 μm, and the film thickness of second dielectric layer 82 is 20 μm to 36 μm.

In PDP 1 according to the present exemplary embodiment, even when Ag is used for display electrodes 6, front glass substrate 3 is small in a coloring phenomenon (yellowing). Moreover, it is possible to achieve dielectric layer 8 that is small in generation of bubbles therein, and superior in insulation withstand voltage performance.

### 3-4. Consideration of Reasons for Generations of Yellowing and Bubbles are Prevented

By adding MoO₃ or WO₃ to the dielectric material containing Bi₂O₃, a compound, such as Ag₂MoO₄, Ag₂Mo₂O₇, Ag₂Mo₄O₁₃, Ag₂WO₄, Ag₂W₂O₇ or Ag₂W₄O₁₃, is easily generated at a temperature of 580° C. or lower. In the present exemplary embodiment, since the firing temperature of dielectric layer 8 is from 550° C. to 590° C., silver ions (Ag⁺) diffused in dielectric layer 8 during the firing step are allowed to react with MoO₃ or WO₃ in dielectric layer 8 to generate a stable compound and stabilized. That is, silver ions (Ag⁺) are stabilized without being reduced. Since silver ions (Ag⁺) are stabilized, the generation of oxygen due to Ag formed into a colloidal state becomes smaller. Consequently, the generation of bubbles in dielectric layer 8 also becomes smaller.

In order to sufficiently obtain the above effect, the content of at least one material selected from MoO₃, WO₃, CeO₂, CuO, Cr₂O₃, Co₂O₃, V₂O₇, Sb₂O₃ and MnO₂ contained in the dielectric material containing Bi₂O₃ is preferably 0.1% by weight or more. The content is more preferably 0.1% by weight or more and 7% by weight or less. In particular, in the case of less than 0.1% by weight, the effect for preventing yellowing becomes insufficient. In the case of more than 7% by weight, yellowing undesirably occurs in the glass.

That is, in dielectric layer 8 in the present exemplary embodiment, the yellowing phenomenon and generation of bubbles are prevented in first dielectric layer 81 that is in contact with metal bus electrodes 4b and 5b containing Ag. Moreover, second dielectric layer 82 formed on first dielectric layer 81 makes a light transmittance high. As a result, PDP 1 that is less extremely small in generation of bubbles and yellowing and has a high light transmittance in dielectric layer 8 as a whole can be realized.

### 4. Detailed Description of Protective Layer 9

Protective layer 9 requires a function to retain electric charges to generate a discharge and a function to emit secondary electrons in a sustain discharge. By improving the electric charge retention performance, an applied voltage can be reduced. By increasing the number of secondary electron emission, a sustain discharge voltage is reduced.

Protective layer 9 according to the present exemplary embodiment includes base film 91 and aggregated particles 92. Base film 91 is made of a nano particle layer formed by nano crystal particles of metal oxides containing at least a first metal oxide and a second metal oxide.

Aggregated particle 92 is made such that a plurality of MgO crystal particles 92a are aggregated.

As shown in FIG. 2A, protective layer 9 according to the present exemplary embodiment includes base film 91 and aggregated particles 92 that are dispersed over base film 91. Protective layer 9, shown in FIG. 2A, is formed by dispersing aggregated particles 92 over base film 91, after base film 91 has been formed.

Moreover, as shown in FIG. 2B, aggregated particles 92 may be dispersed in the nano particle layer. For example, protective layer 9, shown in FIG. 2B, may be formed in the following manner. First, a paste containing nano crystal particles and aggregated particles 92 is applied onto dielectric layer 8. The paste is prepared by dispersing nano crystal particles and aggregated particles 92 in an organic solvent. The applied paste forms a paste layer. Then, the paste layer is subjected to a heating treatment in a baking oven or the like. The heating treatment is carried out, for example, in a temperature range of about 300° C. to 400° C. The atmosphere in the heating treatment is, for example, the atmospheric air. In the case where the paste contains a resin, oxygen is preferably contained in the atmosphere so as to efficiently remove the resin by the heating treatment. The organic solvent is removed by the heating treatment as described above.

The nano crystal particles preferably have an average particle diameter of 10 nm or more and 100 nm or less. The average particle diameter refers to a volume average particle diameter (D50). A laser diffraction-type particle size distribution measuring device MT-3300 (manufactured by Nikkiso Co., Ltd.) is used for measuring the average particle diameter. The average particle diameter of less than 10 nm makes it difficult to carry out uniform dispersion in the paste. The average particle diameter exceeding 100 nm causes a higher surface roughness on the nano particle layer. The higher surface roughness means deviations in the film thickness of the nano particle layer. Therefore, the average particle diameter exceeding 100 nm undesirably causes in-plane deviations of the characteristics of protective layer 9 in PDP 1.

### 4-1. Base Film 91

The first metal oxide and the second metal oxide are two kinds of materials selected from the group consisting of MgO, CaO, SrO and BaO. Moreover, base film 91 has at least one peak in an X-ray diffraction analysis. This peak is located between a first peak in an X-ray diffraction analysis of the first metal oxide and a second peak in an X-ray diffraction analysis of the second metal oxide. The first peak and the second peak have the same plane orientation as that indicated by the peak of base film 91.

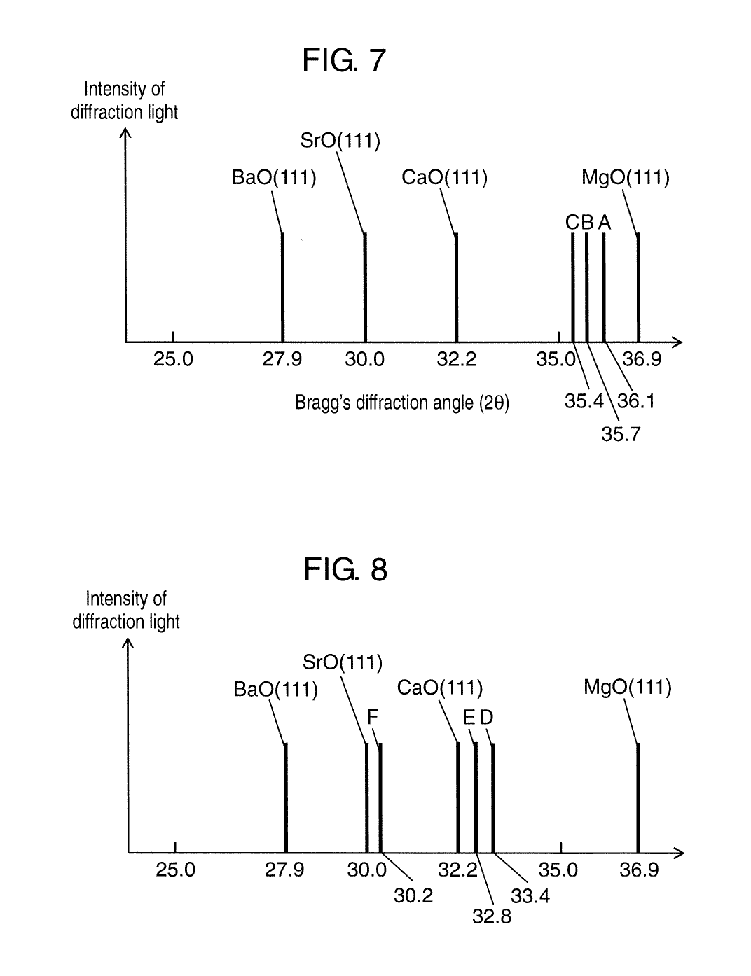

In FIG. 7, the axis of abscissas represents Bragg's diffraction angle (2θ). The axis of ordinates represents the intensity of X-ray diffraction waves. The unit of the diffraction angle is indicated as degrees with one circle being defined as 360 degrees. The intensity of the diffraction light is indicated by an arbitrary unit. The crystal plane orientation is indicated by the inside of parentheses.

As shown in FIG. 7, a (111) plane orientation in a single substance of CaO is indicated by a peak at a diffraction angle of 32.2 degrees. A (111) plane orientation in a single substance of MgO is indicated by a peak at a diffraction angle of 36.9 degrees. A (111) plane orientation in a single substance of SrO is indicated by a peak at a diffraction angle of 30.0 degrees. A (111) plane orientation in a single substance of BaO is indicated by a peak at a diffraction angle of 27.9 degrees.

Base film 91 according to the present exemplary embodiment is made of a nano particle layer formed by nano crystal particles of metal oxides containing at least two kinds of materials selected from the group consisting of MgO, CaO, SrO and BaO.

As shown in FIG. 7, point A represents a peak in a (111) plane orientation of base film 91 formed by nano crystal particles of metal oxides containing two substances of MgO and CaO. Point B represents a peak in a (111) plane orientation of base film 91 formed by nano crystal particles of metal oxides containing two substances of MgO and SrO. Point C represents a peak in a (111) plane orientation of base film 91 formed by nano crystal particles of metal oxides containing two substances of MgO and BaO.

As shown in FIG. 7, the diffraction angle of point A is 36.1 degrees. Point A is located between the peak in (111) plane orientation of the MgO single substance serving as the first metal oxide and the peak in (111) plane orientation of the CaO single substance serving as the second metal oxide.

The diffraction angle of point B is 35.7 degrees. Point B is located between the peak in (111) plane orientation of the MgO single substance serving as the first metal oxide and the peak in (111) plane orientation of the SrO single substance serving as the second metal oxide.

The diffraction angle of point C is 35.4 degrees. Point C is located between the peak in (111) plane orientation of the MgO single substance serving as the first metal oxide and the peak in (111) plane orientation of the BaO single substance serving as the second metal oxide.

As shown in FIG. 8, point D represents a peak in a (111) plane orientation of base film 91 formed by nano crystal particles of metal oxides containing three substances of MgO, CaO and SrO. Point E represents a peak in a (111) plane orientation of base film 91 formed by nano crystal particles of metal oxides containing three substances of MgO, CaO and BaO. Point F represents a peak in a (111) plane orientation of base film 91 formed by nano crystal particles of metal oxides containing three substances of BaO, CaO and SrO.

As shown in FIG. 8, the diffraction angle of point D is 33.4 degrees. Point D is located between the peak in (111) plane orientation of the MgO single substance serving as the first metal oxide and the peak in (111) plane orientation of the CaO single substance serving as the second metal oxide.

The diffraction angle of point E is 32.8 degrees. Point E is located between the peak in (111) plane orientation of the MgO single substance serving as the first metal oxide and the peak in (111) plane orientation of the SrO single substance serving as the second metal oxide.

The diffraction angle of point F is 30.2 degrees. Point F is located between the peak in (111) plane orientation of the MgO single substance serving as the first metal oxide and the peak in (111) plane orientation of the BaO single substance serving as the second metal oxide.

In the present exemplary embodiment, the (111) plane orientation has been exemplified; however, the same is true with respect to the other plane orientations.

The depths of CaO, SrO and BaO from the vacuum level are located at areas shallower than that of MgO. For this reason, it is considered that when, upon driving a PDP, electrons located at energy levels of CaO, SrO and BaO are transferred to the ground state of Xe ions, the number of electrons emitted by the Auger effect becomes greater in comparison with the case where electrons are transferred thereto from the energy level of MgO.

Moreover, as described earlier, the peak of base film 91 in the X-ray diffraction analysis is located between the peak of the first metal oxide and the peak of the second metal oxide. That is, it is considered that since the energy level of base film 91 is located between those of the single substance metal oxides, the number of electrons emitted by the Auger effect becomes greater in comparison with the case where electrons are transferred thereto from the energy level of MgO.

As a result, in comparison with the MgO single substance, base film 91 according to the present exemplary embodiment makes it possible to exert a preferable secondary electron emitting characteristic. Consequently, the sustain voltage can be reduced. In particular, in the case where the partial pressure of Xe serving as a discharge gas is increased in order to enhance luminance, the discharge voltage can be reduced. That is, PDP 1 with high luminance can be achieved even by the use of a low voltage.

### 4-2. Aggregated Particles 92

Aggregated particle 92 is obtained by aggregating a plurality of MgO crystal particles 92a serving as a metal oxide. Aggregated particles 92 are preferably dispersed uniformly over the entire surface of base film 91. Thus, it becomes possible to reduce deviations in discharge voltage within PDP 1.

MgO crystal particle 92a can be produced by either a vapor-phase synthesis method or a precursor firing method. In the vapor-phase synthesis method, first, a metal magnesium material having a purity of 99.9% or more is heated in an atmosphere filled with an inert gas. Moreover, by introducing a small amount of oxygen into the atmosphere, the metal magnesium is directly oxidized. Thus, MgO crystal particle 92a is produced.

In the precursor firing method, an MgO precursor is uniformly fired at a high temperature of 700° C. or higher. Then, by gradually cooling this, MgO crystal particle 92a is produced. As the precursor, for example, at least one compound may be selected from magnesium alkoxide (Mg(OR)₂), magnesium acetyl acetone (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂) and magnesium oxalate (MgC₂O₄). Depending on the selected compounds, normally, the resulting compound may be prepared as a hydrate. A hydrate may be used as the precursor. The compound serving as the precursor is adjusted such that magnesium oxide (MgO) to be obtained after the firing step has a purity of 99.95% or more, and desirably 99.98% or more. In the case where impurity elements, such as various kinds of alkali metals, B, Si, Fe, and Al, are mixed in the compound serving as the precursor in a predetermined amount or more, unnecessary interparticle adhesion or sintering occurs during the heating treatment. As a result, it becomes difficult to obtain MgO crystal particles with high crystallinity. Therefore, it is preferable to preliminarily adjust the precursor by, for example, removing impurity elements from the compound.

By dispersing MgO crystal particles 92a obtained by any of the above-mentioned methods into a solvent, a dispersion solution is prepared. Then, the dispersion solution is applied over the surface of base film 91 by a spraying method, a screen printing method, an electrostatic coating method, or the like. Thereafter, the solvent is removed through the drying or firing step. By the above-mentioned steps, MgO crystal particles 92a are adhered to the surface of base film 91.

### 4-2-1. Detailed Description of Aggregated Particles 92

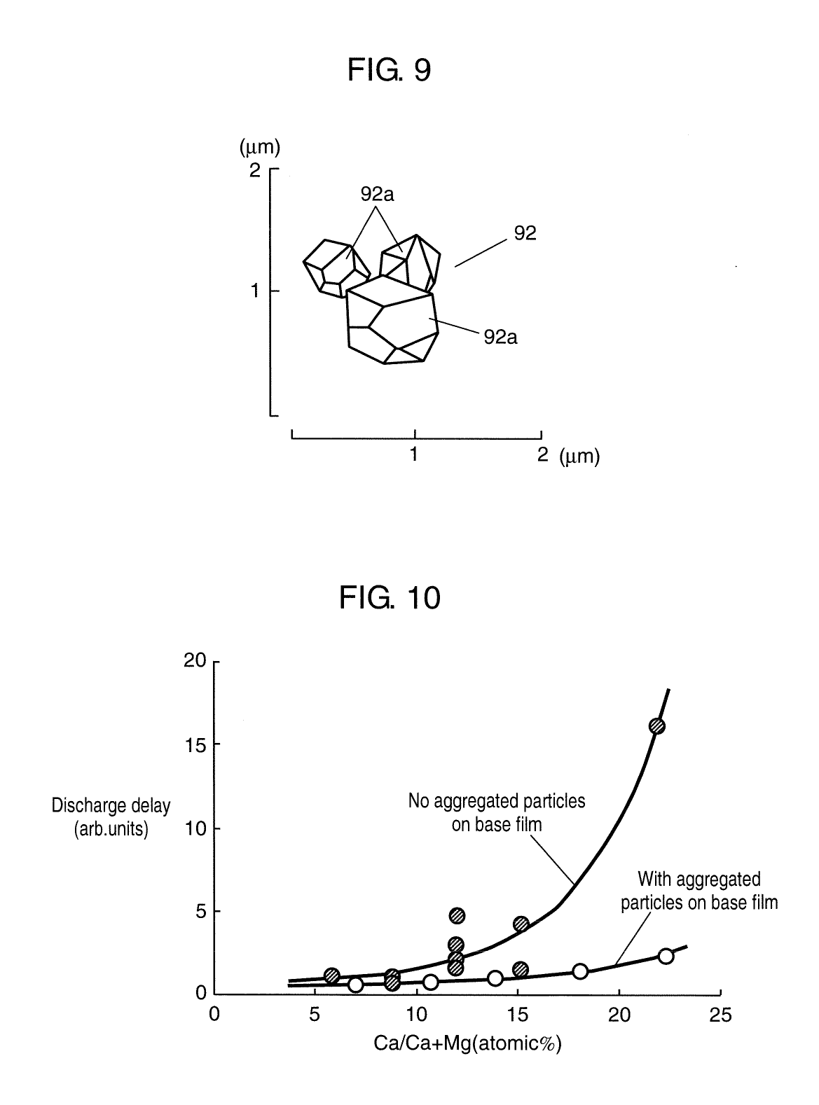

Aggregated particle 92 refers to a particle such that crystal particles 92a having a predetermined primary particle diameter are aggregated or in a necked state. In other words, aggregated particles 92 are not bonded with each other by a strong binding force as a solid substance, they are obtained by aggregating a plurality of primary particles by static electricity, Van der Waals' force, or the like, and moreover, they are bonded with each other by an external force such as an ultrasonic wave so that one portion or entire portion of the particles is decomposed into a primary particle state. As shown in FIG. 9, a particle diameter of aggregated particle 92 is about 1 μm, and crystal particle 92a desirably has a polygonal shape with seven or more surfaces such as a tetradecahedron or a dodecahedron.

Moreover, the particle diameter of the primary particle in crystal particle 92a can be controlled by adjusting forming conditions of crystal particle 92a. For example, in the case of forming the particles by firing the precursor such as magnesium carbonate or magnesium hydroxide, the particle diameter can be controlled by adjusting the firing temperature or firing atmosphere. In general, the firing temperature is selected from a range of 700° C. to 1500° C. By setting the firing temperature to a relatively high level of 1000° C. or higher, the particle diameter can be controlled to about 0.3 μm to 2 μm. Moreover, by heating the precursor, a plurality of the primary particles are aggregated or necked with each other in the forming process so that aggregated particles 92 can be obtained.

Through experiments carried out by the present inventors, it has been confirmed that aggregated particle 92 obtained by aggregating a plurality of MgO crystal particles has an effect for suppressing “discharge delay” mainly in address discharge and an effect for alleviating a temperature dependence of the “discharge delay”. Aggregated particle 92 is superior in an initial electron emission characteristic in comparison with that of base film 91. Therefore, in the present exemplary embodiment, aggregated particles 92 are disposed as an initial electron supply unit that is required at the time of a rise of a discharge pulse.

It is considered that the “discharge delay” is mainly caused by the fact that the initial electrons serving as a trigger upon starting a discharge are emitted from the surface of base film 91 to discharge space 16 at an insufficient amount. Therefore, in order to stably supply the initial electrons to discharge space 16, aggregated particles 92 are dispersed over the surface of base film 91. Thus, at the time of the rise of the discharge pulse, abundant electrons are allowed to exist in discharge space 16, which makes it possible to eliminate the discharge delay. Therefore, this initial electron emission characteristic makes it possible to carry out a high-speed driving operation with a good discharge response, even in the case of PDP 1 with high precision, or the like. In the configuration in which aggregated particles 92 of a metal oxide are disposed over the surface of base film 91, an effect for alleviating the temperature dependence of the “discharge delay” can be obtained in addition to the effect for suppressing the “discharge delay” mainly in address discharge.

### 5. Evaluation

### 5-1. Evaluation 1

A plurality of PDPs 1 having different configuration of base film 91 were produced. Into each of PDPs 1, a mixed gas of Xe and Ne (Xe: 15%) with a pressure of 60 kPa was sealed. Base film 91 of sample A is composed of nano crystal particles of metal oxides containing MgO and CaO. Base film 91 of sample B is composed of nano crystal particles of metal oxides containing MgO and SrO. Base film 91 of sample C is composed of nano crystal particles of metal oxides containing MgO and BaO. Base film 91 of sample D is composed of nano crystal particles of metal oxides containing MgO, CaO and SrO. Base film 91 of sample E is composed of nano crystal particles of metal oxides containing MgO, CaO and BaO. Moreover, in a comparative example, base film 91 is composed of a single substance of MgO.

With respect to each of samples A to E, a sustain voltage was measured. When the comparative example was supposed to be 100, sample A was 91, sample B was 87, sample C was 86, sample D was 82, and sample E was 83. Samples A to E are PDPs that are produced by a normal production method. That is, samples A to E are PDPs that are produced by a production method without having a reducing organic gas introducing step.

In the case where the partial pressure of Xe in the discharge gas was increased from 10% to 15%, the luminance was increased by about 30%; however, in the comparative example, the sustain voltage was increased by about 10%.

On the other hand, in each of sample A, sample B, sample C, sample D and sample E, the sustain voltage could be reduced by about 10% to 20% in comparison with the comparative example.

Then, PDPs 1 having base films 91 with the same configurations as samples A to E were manufactured by the production method according to the present exemplary embodiment. The first temperature profile was used as steps of sealing step C1 to discharge gas supply step C4.

As the reducing organic gas, for example, propylene, cyclopropane, acetylene and ethylene were used. The sustain voltage of each PDP 1 according to the present exemplary embodiment was further reduced by about 5% in comparison with those of samples A to E.

### 5-2. Evaluation 2

PDPs with protective layers having different configurations were produced experimentally. As shown in FIG. 10, the conditions are the case where only base film 91 is provided and the case where aggregated particles 92 are dispersed over base film 91. Base film 91 was formed by nano crystal particles of metal oxides containing MgO and CaO. That is, this corresponds to sample A mentioned earlier. In the case where only base film 91 is provided, the discharge delay becomes longer as the Ca concentration increases. On the other hand, in the case aggregated particles 92 were dispersed over base film 91, the discharge delay could be greatly reduced. That is, even when the Ca concentration increases, the discharge delay hardly becomes longer. Upon measuring the discharge delay, the method described in JP-A No. 2007-48733 was used. The measuring method will be described later.

### 5-3. Evaluation 3

PDPs with protective layers having different configurations were produced experimentally.

Sample 1 is a PDP having only a protective layer made of MgO.

Sample 2 is a PDP having a protective layer made of only MgO doped with an impurity such as Al or Si.

Sample 3 is a PDP on which only primary particles of crystal particles 92a made of MgO are dispersed over an MgO base film.

In sample 4, sample A mentioned earlier was used as protective layer 9. That is, protective layer 9 includes base film 91 formed by nano crystal particles of metal oxides containing MgO and CaO and aggregated particles 92 that are virtually uniformly dispersed over the entire surface of base film 91. In this case, base film 91 has a diffraction angle of 36.1 degrees indicating a peak of (111) plane in an X-ray diffraction analysis.

Samples 1 to 4 were produced by the aforementioned production method. In particular, with respect to the introduction and exhaustion of the reducing organic gas, the first temperature profile was used. Therefore, samples 1 to 4 differ from one another only in the configuration of protective layer 9.

With respect to samples 1 to 4, electron emission performance and electric charge retention performance were measured.

The electron emission performance is a value that is shown to increase as an electron emission amount becomes larger. The electron emission performance is expressed as an initial electron emission amount determined by a surface state of the discharge, a type of gas, and the state of gas. The initial electron emission amount can be measured by a method in which the surface is irradiated with an ion or electron beam and an electronic current amount emitted from the surface is measured. However, this method is difficult to carry out in a nondestructive way. For this reason, a method disclosed in JP-A No. 2007-48733 was utilized. In other words, among delay times at the time of discharge, a numeric value which provides an indication of ease of discharge generation, called a statistical delay time, was measured. By integrating an inverse number of the statistical delay time, a numeric value that lineally corresponds to the emission amount of the initial electrons is obtained. The delay time at the time of discharge refers to a period of time from rising of the address discharge pulse until the address discharge is generated later. It is considered that the discharge delay is mainly caused by the fact that the initial electron serving as a trigger upon generation of the address discharge is hardly emitted from the surface of the protective layer to the discharge space.

As an index for the electric charge retention performance, a voltage value (hereinafter, referred to as “Vscn lighting voltage) to be applied to a scan electrode, which is required for suppressing an electric charge emission phenomenon of a PDP, was used. That is, the lower the Vscn lighting voltage is, the higher the electric charge retention capability is. When the Vscn lighting voltage is low, the PDP can be driven at a low voltage. Consequently, as a power supply, various electric parts and the like, those parts having a small withstand voltage and capacity can be used. In current products, as a semiconductor switching element such as a MOSFET for applying a scan voltage to a sequential panel, an element having a withstand voltage of about 150 V has been used. By taking into consideration variations caused by temperatures, the Vscn lighting voltage is desirably suppressed to 120 V or less.

In general, the electron emission capability and the charge retention capability of the protective layer in the PDP are contrary to each other. By changing a condition for forming the protective layer, or doping an impurity such as Al, Si, or Ba in the protective layer, the electron emission performance can be improved. However, the Vscn lighting voltage also rises as an adverse effect.

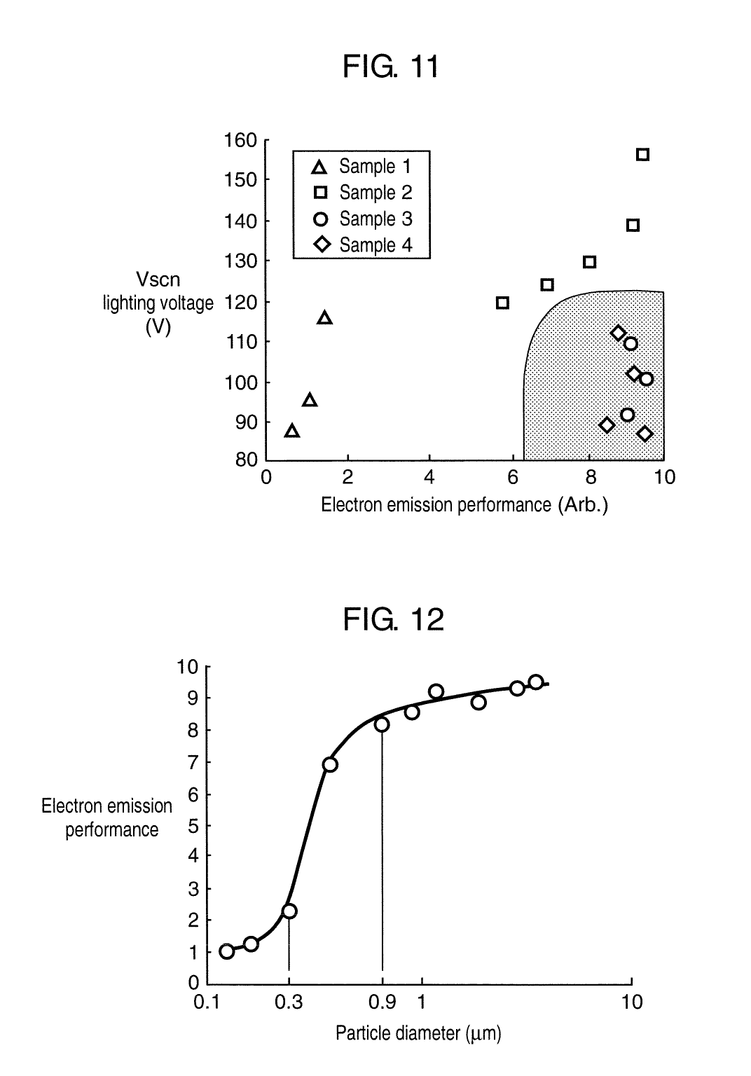

As is clear from FIG. 11, the electron emission performance of the protective layer of each of sample 3 and sample 4 is 8 times or greater than that of sample 1. The electric charge retention performance of protective layer 9 of each of sample 3 and sample 4 is 120 V or less in the Vscn lighting voltage. Therefore, the PDPs of sample 3 and sample 4 are further effectively used for PDPs in which the number of scanning lines increases due to high definition and the cell size thereof tends to be decreased. In other words, the PDPs of sample 3 and sample 4 satisfy both the electron emission capability and the electric charge retention capability, to thereby achieve a good image display with a low voltage.

### 5-4. Evaluation 4

The following description will discuss the particle diameter of aggregated particle 92 in detail. In this case, the average particle diameter of aggregated particles 92 was measured by SEM observation of aggregated particles 92.

As shown in FIG. 12, when the average particle diameter becomes smaller to about 0.3 μm, the electron emission performance is lowered, while, when it is about 0.9 μm or more, high electron emission performance can be obtained.

In order to increase the number of electrons emitted in a discharge cell, the number of crystal particles per unit area on protective layer 9 is desirably large.

According to the experiment by the present inventors, when crystal particles 92a and 92b are present in a portion corresponding to the top portion of barrier rib 14 that is in close contact with protective layer 9, the top portion of barrier rib 14 may be damaged. It has been found that in such a case, due to a damaged material of barrier rib 14 being placed on a phosphor or the like, a phenomenon in which the corresponding cell fails to be normally turned on or off occurs. Since the damage of the barrier rib does not easily occur unless aggregated particles 92 are present in a portion corresponding to the top portion of the barrier rib. That is, the probability of occurrence of damage in barrier rib 14 becomes higher as the number of aggregated particles 92 to be dispersed becomes greater. From this point of view, when the average particle diameter becomes large of about 2.5 μm, the probability of occurrence of damage in the barrier rib becomes abruptly higher. On the other hand, when the average particle diameter is smaller than 2.5 μm, the probability of occurrence of damage in the barrier rib is suppressed to a comparatively small level. That is, aggregated particles 92 preferably have an average particle diameter of 0.9 μm or more and 2.5 μm or less.

As described above, in PDP 1 having protective layer 9 according to the present exemplary embodiment, it becomes possible to obtain such a PDP having 8 or more in the electron emission capability and a Vscn lighting voltage of 120 V or less in the charge retention capability.

### 6. Wrap-Up

The method for producing PDP 1 disclosed in the present exemplary embodiment includes the following steps. By introducing a gas containing a reducing organic gas into a discharge space, protective layer 9 is exposed to the reducing organic gas. Then, the reducing organic gas is exhausted from the discharge space. Then, a discharge gas is enclosed to the discharge space.

Protective layer 9 exposed to the reducing organic gas has generation of oxygen deficiency. It is considered that the generation of oxygen deficiency makes the secondary electron emission capability of the protective layer high. Therefore, PDP 1 produced by the production method according to the present exemplary embodiment makes it possible to reduce a sustain voltage.

Moreover, the reducing organic gas is preferably a hydrocarbon-based gas without containing oxygen. This is because the reducing capability is improved by the fact that no oxygen is contained.

Furthermore, the reducing organic gas is preferably at least one gas selected from acetylene, ethylene, methylacetylene, propadiene, propylene, cyclopropane, propane and butane. This is because those reducing organic gases are easily handled in the production steps. This is also because those reducing organic gases are easily decomposed.

The present exemplary embodiment has exemplified a production method in which, after the discharge space has been exhausted, a gas containing a reducing organic gas is introduced into the discharge space. However, by continuously supplying the gas containing a reducing gas into the discharge space without exhausting the discharge space, the gas containing a reducing organic gas may also be introduced into the discharge space.

In the case where protective layer 9 includes crystal particles 92a of metal oxides or aggregated particles 92 obtained by aggregating a plurality of crystal particles 92a of metal oxides on base film 91, high electric charge retention performance and high electron emission performance are exerted. Therefore, even in the case of a PDP with high precision, a high-speed driving operation can be realized at a low voltage in the entire of PDP 1. Moreover, it is possible to achieve high-quality image display performance while suppressing lighting failure.

Moreover, the present exemplary embodiment has exemplified MgO as crystal particles of a metal oxide. However, by using other single crystal particles, that is, crystal particles of metal oxides such as Sr, Ca, Ba, and Al having high electron emission performance similar to MgO, the same effects can be obtained. Therefore, the crystal particles of the metal oxide are not limited to MgO.

### INDUSTRIAL APPLICABILITY

As described above, the technique disclosed in the present exemplary embodiment is provided with display performance with high definition and high luminance, and is useful in realizing a PDP with low power consumption.

### REFERENCE MARKS IN THE DRAWINGS

1 PDP
2 Front plate
3 Front glass substrate
4 Scan electrode
4a, 5a Transparent electrode
4b, 5b Metal bus electrode
5 Sustain electrode
6 Display electrode
7 Black stripe
8 Dielectric layer
9 Protective layer
10 Rear plate
11 Rear glass substrate
12 Data electrode
13 Insulating layer
14 Barrier rib
15 Phosphor layer
16 Discharge space
81 First dielectric layer
82 Second dielectric layer
91 Base film
92 Aggregated particles
92a Crystal particles

1. A method for producing a plasma display panel including a discharge space and a protective layer that faces the discharge space, wherein
the protective layer includes a nano particle layer formed by nano crystal particles of metal oxides containing at least a first metal oxide and a second metal oxide;
the nano particle layer has at least one peak in an X-ray diffraction analysis;
the peak is located between a first peak in the X-ray diffraction analysis of the first metal oxide and a second peak in the X-ray diffraction analysis of the second metal oxide;
the first peak and the second peak have the same plane orientation as the plane orientation indicated by the peak;
the first metal oxide and the second metal oxide are two kinds of oxides selected from the group consisting of magnesium oxide, calcium oxide, strontium oxide and barium oxide;
the method comprising:
exposing the protective layer to the reducing organic gas by introducing a gas containing a reducing organic gas into the discharge space;
exhausting the reducing organic gas from the discharge space; and
enclosing a discharge gas to the discharge space.

2. The method for producing a plasma display panel according to claim 1, wherein the reducing organic gas is a hydrocarbon-based gas without containing oxygen.

3. The method for producing a plasma display panel according to claim 2, wherein the reducing organic gas is at least one gas selected from acetylene, ethylene, methylacetylene, propadiene, propylene, cyclopropane, propane and butane.

4. The method for producing a plasma display panel according to claim 1, wherein the nano crystal particles have an average particle diameter of 10 nm or more and 100 nm or less.

5. The method for producing a plasma display panel according to claim 1, wherein the protective layer further comprises aggregated particles obtained by aggregating a plurality of crystal particles of magnesium oxide dispersed over the nano particle layer; and
after forming the nano particle layer, the aggregated particles are dispersed over the nano particle layer.

6. The method for producing a plasma display panel according to claim 1, wherein the protective layer further comprises aggregated particles obtained by aggregating a plurality of crystal particles of magnesium oxide dispersed over the nano particle layer;
a paste layer is formed by applying a paste containing the nano crystal particles and the aggregated particles thereto; and
the paste layer is then subjected to a heating treatment.

7. The method for producing a plasma display panel according to claim 5, wherein the nano crystal particles have an average particle diameter of 10 nm or more and 100 nm or less; and
the aggregated particles have an average particle diameter of 0.9 μm or more and 2.5 μm or less.

8. The method for producing a plasma display panel according to claim 6, wherein the nano crystal particles have an average particle diameter of 10 nm or more and 100 nm or less; and
the aggregated particles have an average particle diameter of 0.9 μm or more and 2.5 μm or less.
